(19) United States
(12) Patent Application Publication
(10) Pub. No.: US 2007/0082661 A1
(43) Pub. Date: Apr. 12, 2007

(54) Method and apparatus for configuration of modular devices

(76) Inventors: Greg R. Black, Vernon Hills, IL (US); Joel A. Clark, Woodbridge, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/248,978

(22) Filed: Oct. 11, 2005

(51) Int. Cl. H04M 3/00

(52) U.S. Cl. 455/418

(57) ABSTRACT

A method and apparatus is provided for configuring a wireless communication module (220) for optimal performance with a portable communication handset (210). When coupling of a portable electronic handset (210) and a wireless communication module (220) is detected (602, 702) the portable electronic handset (210) uploads configuration information (604, 606, 608, 610) to the wireless communication module (220). The wireless communication module (220) receives the configuration information (704, 706, 708, 710) from the portable communication device (210) and configures the operational parameters of the wireless communication module (220) in response to the configuration information (714, 716, 718, 720).

### REFERENCE TO RELATED APPLICATION

This application is related to U. S. Non-Provisional Patent Application No. ______, entitled “METHOD AND APPARATUS FOR MODULE AUTHENTICATION” and filed Sep. 30, 2005.

### FIELD OF THE INVENTION

The present invention generally relates to portable electronic devices, and more particularly relates to a method and apparatus for configuring operational characteristics of modules of a modular portable electronic device.

### BACKGROUND OF THE INVENTION

Over the course of a product's life cycle, a device is subject to many changes in the product's features. In addition, a product family may offer many different features to distinguish high-cost models from low-cost models. Portable electronic devices, such as cellular phones, are experiencing this pressure to provide distinguishable models in product families as well as to provide different and more features in some or all models.

Having different models with different functionalities makes it difficult to offer low cost models because each different model may require a different design and different manufacturing. Offering a number of low cost models with different functionalities and features is also difficult because of the scalability issue. For example, today's portable electronic devices may require differing user interfaces and/or differing displays and display drivers. In addition, higher functionality portable electronic devices, such as portable communication devices, may require increased signaling computationability, while lower functionality portable communication devices require less signaling computationability. Having many different model portable electronic devices is less scalable in that changing out displays or user interfaces may require printed circuit board modifications. In addition, while signaling computation can be facilitated by, for example, baseband memory and the least expensive solution is a read-only memory (ROM) baseband memory, expensive memory, such as flash memory, is required to facilitate firmware changes. One solution is to provide a plurality of modules, which together make up the portable electronic device, where each module is manufactured separately.

The benefit of modular portable electronic devices is that one module may work with a number of other modules. However, operational characteristics of the portable electronic device may require configuring the operation of one module to efficiently operate with another module. The manufacturer wants to maintain control over modular interoperability to limit the time-to-market burden and expense of obtaining regulatory approvals for all combinations of modules. In addition, the manufacturer may want to maintain control over the operational characteristics of a portable electronic device such that a low cost device having a particular module will have certain operational characteristics while higher cost devices having the same particular module will have different operational characteristics.

Thus, what is needed is a method and apparatus for configuring the operational characteristics of a modular portable electronic device. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a diagram of a communication system in accordance with an embodiment of the present invention;

FIG. 2 is a breakaway view of a combination portable communication device and wireless communication module in accordance with an embodiment of the present invention;

FIG. 3 is a side view of the combination portable communication device and wireless communication module in accordance with an embodiment of the present invention;

FIG. 4 is a block diagram of the portable communication device of FIG. 3 in accordance with the embodiment of the present invention;

FIG. 5 is a block diagram of the wireless communication module of FIG. 3 in accordance with the embodiment of the present invention;

FIG. 6 is a flowchart of the configuration procedure of the portable communication device of FIG. 4 in accordance with the embodiment of the present invention; and

FIG. 7 is a flowchart of the configuration procedure of the wireless communication module of FIG. 5 in accordance with the embodiment of the present invention.

### DETAILED DESCRIPTION OF THE INVENTION

A method and apparatus is provided for configuring a wireless communication module for optimal performance with a portable communication handset. When coupling of a portable electronic device and a wireless communication module is detected the portable electronic device uploads configuration information to the wireless communication module. The wireless communication module receives the configuration information from the portable electronic device and configures the operational parameters of the wireless communication module.

The following detailed description of the invention is merely exemplary in nature and is not intended to limit the invention or the application and uses of the invention. Furthermore, there is no intention to be bound by any theory presented in the preceding background of the invention or the following detailed description of the invention.

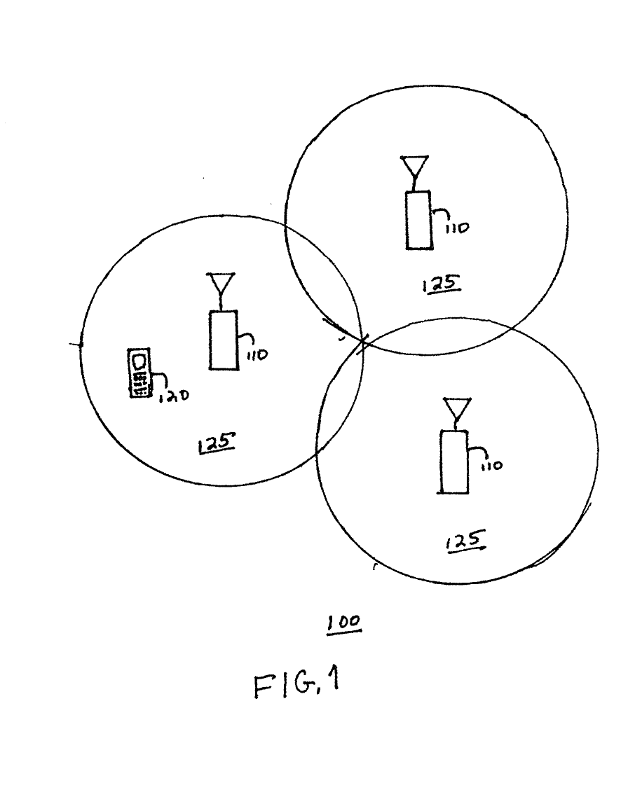

Referring to FIG. 1, a communication system 100 in accordance with an embodiment of the present invention includes a plurality of base stations 110 and a wireless communication device 120. The communication system has public land mobile network (PLMN) information associated therewith and the wireless communication device 120, if having appropriate PLMN information associated therewith, communicates in the communication system 100 by communicating with the plurality of base stations 110 on one or more of a plurality of channels. Associated with each of the plurality of base stations 110 is a coverage area 125 wherein the wireless communication device 120 can receive signals from and transmit signals to such one of the plurality of base stations 110 on any of the plurality of channels.

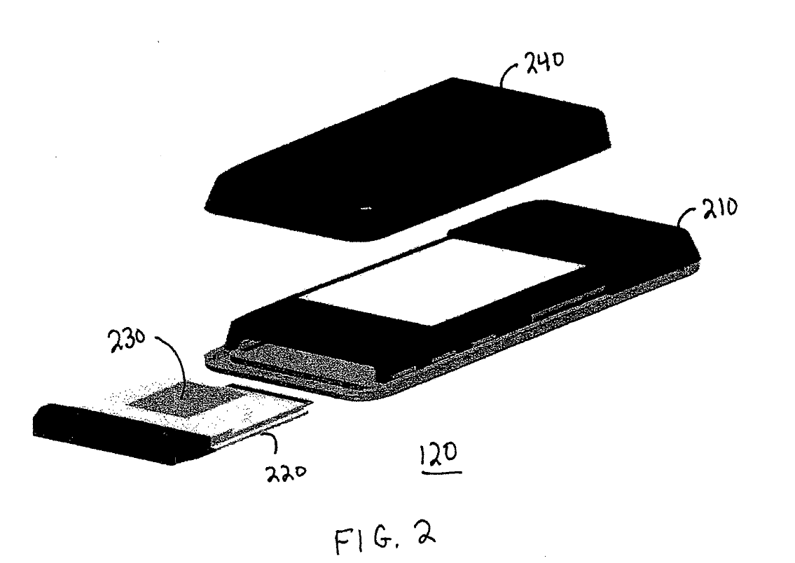

Referring to FIG. 2, a breakaway view from a bottom right rear angle of the wireless communication device 120 showing assembly thereof is depicted. The wireless communication device 120 includes a first module 210 and a second module 220. The first module 210 is a portable communication device or, more specifically, a portable communication handset. The second module 220 is a wireless communication module, such as a wireless communication modem, for coupling to the portable communication device 210 to operate together as a wireless communication device 120.

A subscriber identity module (SIM) 230 couples to the wireless communication modem 220 for permitting operation of the wireless communication device 120 in the communication system 100 as described hereinbelow. After the portable communication handset 210 and the wireless communication modem 220 are coupled together, the rear case 240 is connected to complete manufacturer's assembly for enclosing both modules together into one wireless communication device 120.

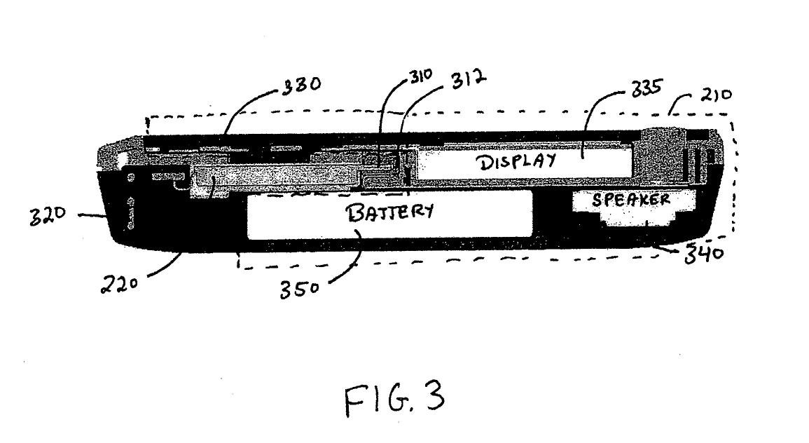

The side planar view of FIG. 3 shows the completed wireless communication device 120. The wireless communication modem 220 has a module coupler 310 for physically and electrically coupling the wireless communication modem 220 to a coupler 312 of the portable communication handset 210. The wireless communication modem 220 also has an antenna 320 connected thereto for transmission of signals to and reception of signals from the base stations 110 (FIG. 1). User interface devices coupled to the portable communication handset 210 include a telephonic numeric keypad 330, a display 335 and a speaker 340. A battery 350 is also coupled to the portable communication handset 210 for provision of power to the portable communication handset 210 and the wireless communication modem 220.

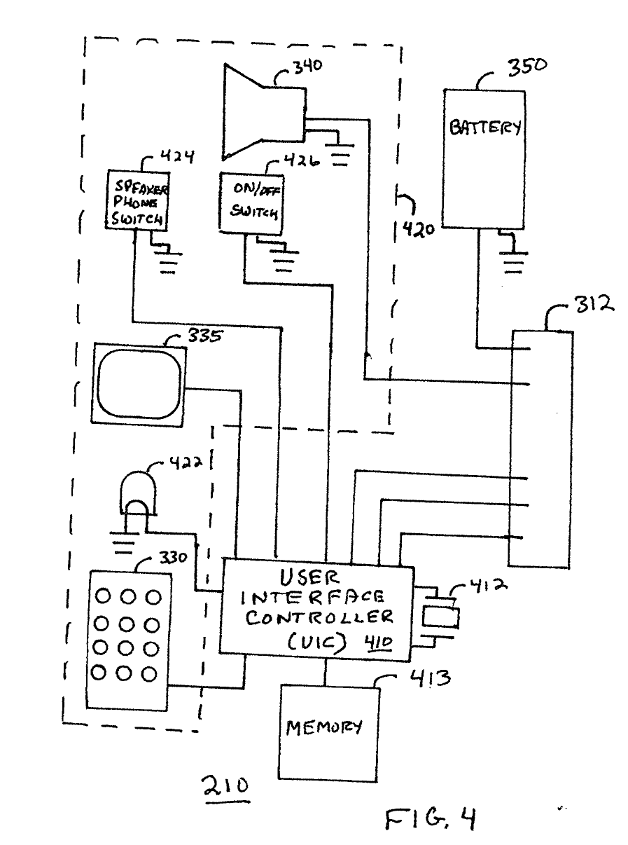

Referring to FIG. 4, a block diagram of the portable communication handset 210 includes a user interface controller 410 coupled to a clock 412 to provide clocking signals for operation of the controller 410 and a memory 413 storing information for the operation of the user interface controller 410. The controller 410 is coupled to user interface devices 420 which include the telephonic numeric keypad 330, the display 335, the speaker 340 and a light 422, such as a backlight for the display 335. The user interface devices 420 also include switches such as a switch 424 for activating speaker phone capability if the wireless communication device 120 permits speaker phone operation and a switch 426 for turning the wireless communication device 120 on or off (i.e., for providing operational information setting a state of the wireless communication device 120 as operable or as inoperable).

The coupler 312, which physically and electrically couples the portable communication handset 210 to the wireless communication modem 220, is coupled to the controller 410 for receiving signals therefrom and providing signals thereto. The speaker 340, while physically mounted in the portable communication handset 210, is coupled to the coupler 312 for receiving operational signals from the wireless communication modem 220 for alerting the user such as ringing tones. The battery 350 also is coupled to the coupler 312 for providing power to the wireless communication device 120. While in the embodiment described herein, the user interface devices 420 are coupled to the user interface controller 410, one or more of the user interface devices 420 (e.g., the keypad 330, the display 335, or the switches 424, 426) could be resident in the handset yet coupled to the coupler 312 for providing signals directly to or receiving operational signals directly from the wireless communication modem 220. Alternatively, either of the switches 424, 426 or the keypad 330 could be on the wireless communication modem 220.

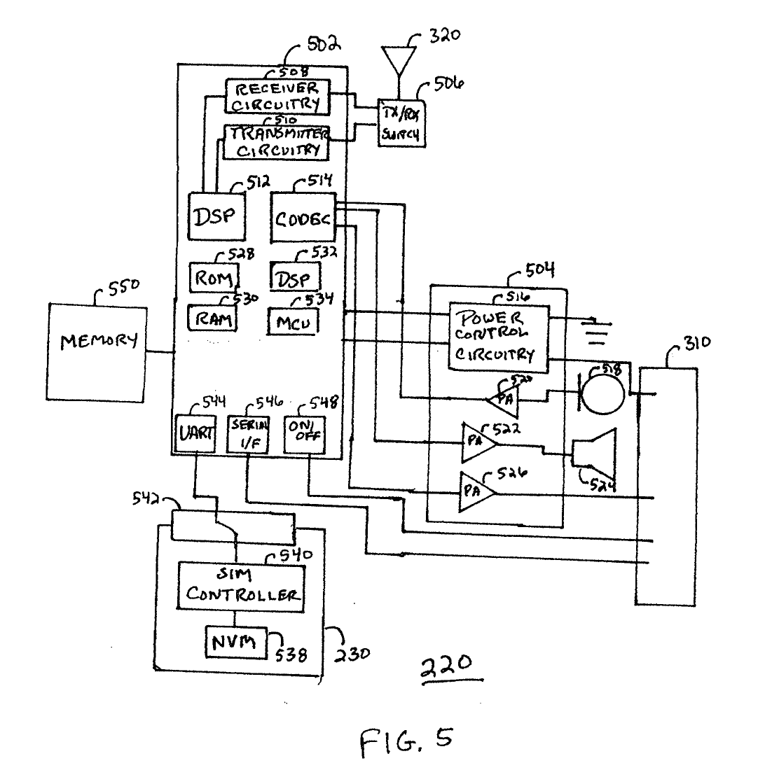

Referring to FIG. 5, the wireless communication modem 220 includes a transceiver baseband controller 502 and a power management integrated circuit (IC) 504. The antenna 320 receives and transmits radio frequency (RF) signals and is coupled to a receive/transmit switch 506. The receive/transmit switch 506 selectively couples the antenna 320 to receiver circuitry 508 and transmitter circuitry 510 in the baseband controller 502 in a manner familiar to those skilled in the art. The receiver circuitry 508 demodulates and decodes the RF signals to derive information and is coupled to a peripheral digital signal processor (DSP) 512 for providing the decoded information thereto for utilization thereby in accordance with the function(s) of the wireless communication device 120. The DSP 512 also provides information to the transmitter circuitry 510 for encoding and modulating information into RF signals for transmission from the antenna 320.

A codec 514 provides signals to power control circuitry 516 on the power management IC 504 which provides power from the battery 350 coupled through the coupler 310 to the circuits and devices of the portable communication handset 210 and the wireless communication module 220 for operation of the wireless communication device 120. For communication on the wireless communication device 110, the codec 514 receives signals from a microphone 518 amplified by a power amplifier 520 and provides signals to a power amplifier 522 for powering a speaker 524. In addition, the codec 514 provides alert signals to a power amplifier 526 which is coupled to the speaker 340 through the coupler 310. Though depicted in the present embodiment as part of the transceiver baseband controller 502, the codec 514 could alternatively reside in the portable communication handset 210 for operation of the speaker 340 therein.

The subscriber identity module (SIM card) 230 includes a SIM controller 538 and a SIM non-volatile memory (NVM) 540. The SIM controller 538 is connected to a SIM coupler 542 for physically and electrically coupling the SIM card 230 to the wireless communication module 220. The SIM card 230 could, on the other hand, be coupled to the portable communication handset 210 through coupler 542. As is known to those skilled in the art, the SIM NVM stores subsidy lock information which includes an International Mobile Subscriber Identity (IMSI) and optionally group identifier 1 and 2 information (GID1 and GID2). Contained within the IMSI value is the home public land mobile network (HPLMN) information designating the PLMN communication system 100 to which the user has subscribed for service. The wireless communication device 110 is authorized to operate in this HPLMN as well as in any other PLMN with which the HPLMN has roaming agreements.

As is also known to those skilled in the art, the transceiver baseband controller includes a read only memory (ROM) 528, a random access memory (RAM) 530, a DSP 532 and a microcontroller unit (MCU) 524. A SIM universal asynchronous receiver/transmitter (SIM UART) 544 is coupled to the SIM controller 540 through the SIM coupler 542, a serial I/F device 546 is coupled to the user interface controller 410 through the coupler 310 and the module coupler 312, and a on_off/general purpose input_output (GPIO) device 548 is also coupled to the user interface controller 410 through the coupler 310 and the module coupler 312 alternatively, the on_off/GPIO device 548 could be directly coupled to the on_off switch 426). A memory 550 is coupled to the transceiver baseband IC 502 for storing information used for the operation of the wireless communication device 120.

Thus it can be seen that the present invention allows a single wireless communication module 220 to provide RF and audio modem functions over a range of products having differing transducer capabilities. This is achieved by separation of the audio and RF functions into the wireless communication module 220 and the user interface functions into the portable communication handset 210. In another embodiment of the present invention, the wireless communication module 220 could be designed only for RF modem functions, with some or all of the audio apparati on the portable communication handset 210 side of the couplers 312, 310.

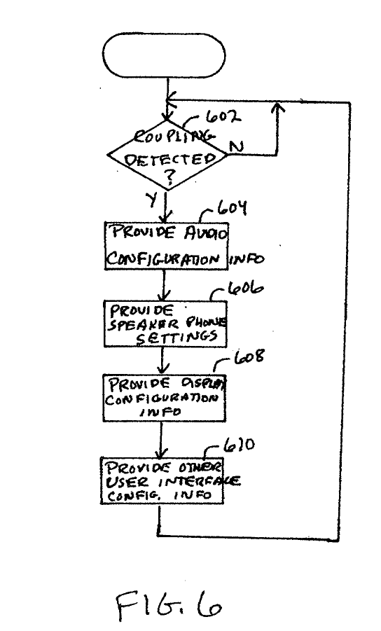

Referring to FIG. 6, the configuration procedure of the portable communication handset 210 in accordance with the embodiment of the present invention first determines if coupling of the wireless communication modem 220 to the portable communication handset 210 has been detected 602. This could be actual detection of the coupling of the modem 220 to the handset 210 or powering up of the wireless communication device 120 and determining that the modem 220 has been coupled 602 while power was off.

When coupling of the modem 220 is detected 602, the user interface controller 413 provides audio configuration information from the memory 413 to the wireless communication modem 220 for use thereby 604. As it may be necessary for the wireless communication modem 220 to optimize RF and audio performance, the handset 210 provides audio path configuration information such as RF compensation information including transmitter circuitry 510 power settings or power limits for different band and sub-bands, receiver circuitry 508 level settings which report offsets for different bands and sub-bands, and antenna related gain or impedance settings, as well as audio compensation information including uplink and downlink gain offsets, audio filter parameters, and transducer isolation data and echo-cancellation parameters. In addition, to better match the handset 210 to the modem 220 to improve interoperability, the audio configuration information may include information identifying the handset 210 model, the manufacturer thereof or the types of transducers utilized thereby.

After providing the audio configuration information 604, the handset 210 next provides to the modem 220 configuration information to permit or prevent speakerphone operation 606. Then display configuration information is provided 608, such as the size or resolution interface format of the display 335 so that the information provided from the modem 220 to the handset 210 for display on the display 335 is properly configured. This information may also include font related information, such as Korean or Chinese fonts, so that the information generated by the modem 220 for presentation to the user is properly configured to display the appropriate fonts on the display 335. Finally, other user interface configuration information is provided 610 to the modem 220 to define the user interface properties, such as defining functionality of various key inputs on the telephonic numeric keypad 330 or defining touchscreen inputs, so that the modem 220 can properly interpret user inputs as received.

The order of the configuration steps 604, 606, 608, 610 is not important, nor is it necessary that each of the steps be performed in all instances. One of the purposes of the present invention is to identify the handset 210 features such as RF bands and audio paths and compensate for variable RF and audio performance caused by the handset 210 model. For example, the audio and RF transducers may have variable performance across a product family. Another purpose is to properly configure the wireless communication modem 220 to operate with the portable communication handset 210.

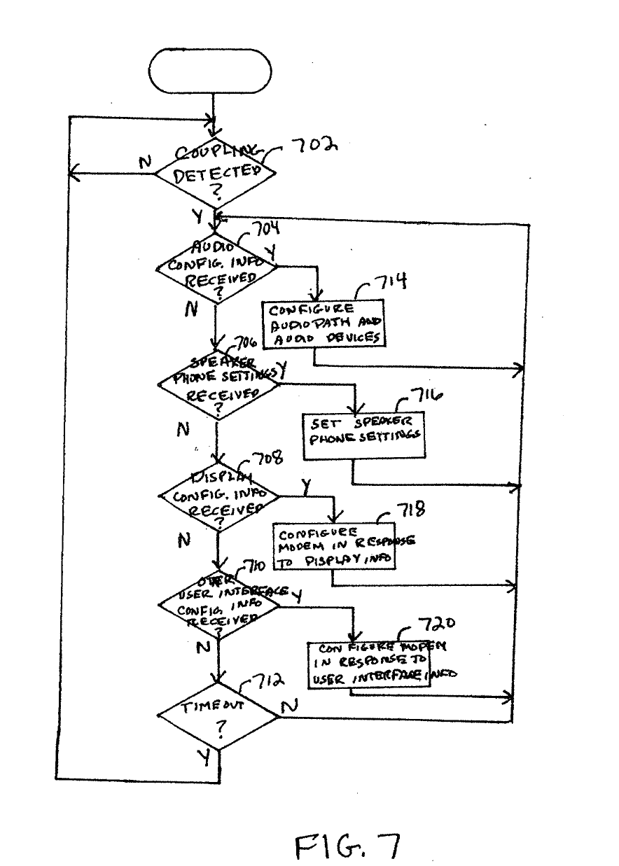

The flowchart of FIG. 7 describes the configuration process of the wireless communication modem 220. The wireless communication modem 220 first determines if the portable communication handset 210 has been coupled thereto 702. When coupling of the modem 220 is detected 702, the wireless communication modem 220 awaits reception of audio configuration information 704, speakerphone setting information 706, display configuration information 708, other user interface configuration information 710 or timeout 712. Timeout is calculated to be sufficient time for the user interface controller 410 to retrieve and provide all necessary configuration information.

When audio configuration information is received 704, the wireless communication modem 220 configures operational parameters of the audio output devices as well as optimizing RF and audio performance by setting audio gain path parameters in response to audio configuration information such as RF compensation information including transmitter circuitry 510 power settings, receiver circuitry 508 level settings, antenna related settings, and audio compensation information including uplink and downlink gain offsets, audio filter parameters, and transducer isolation data and echo-cancellation parameters. In addition, to better match the handset 210 to the modem 220 to improve interoperability, the audio configuration information may include information identifying the handset 210 model, the manufacturer thereof or the types of transducers utilized thereby.

When speakerphone setting information is received 706, the modem 220 configures operation of the wireless communication device 120 to permit or prevent speakerphone operation 716. When display configuration information is received 708, the modem 220 configures operation thereof consistent with the size and resolution of the display 335 as well as fonts displayable thereon 718. Finally, when other user interface configuration information is received 710 by the modem 220, operation is defined and optimized for use with the user interface operational parameters provided thereto.

The configuration of the wireless communication modem 220 by information from the portable communication handset 210 allows a single modem 220 to provide RF and audio modem functions over a range of products having different transducer capabilities by configuring the operational parameters of the modem 220 audio and RF performance according to the configuration information passed from the handset 210 to the modem 220.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method in a portable electronic device having a wireless communication module coupleable thereto, the method comprising the steps of:
coupling the portable electronic device to the wireless communication module; and
providing configuration information to the wireless communication module for configuring the operational parameters thereof.

2. The method of claim 1 wherein the step of providing the configuration information comprises the step of providing audio configuration information to the wireless communication module for configuring the operational parameters of audio output devices.

3. The method of claim 2 wherein the step of providing the audio configuration information comprises the step of providing audio path gain setting information to the wireless communication module for configuring the operational parameters of the audio output devices.

4. The method of claim 2 wherein the step of providing the audio configuration information comprises the step of providing speaker phone setting information to the wireless communication module for configuring the operational parameters of the audio output devices to operate as a speaker phone or not operate as a speaker phone.

5. The method of claim 1 wherein the step of providing the configuration information comprises the step of providing display configuration information to the wireless communication module for configuring display settings thereof.

6. The method of claim 5 wherein the step of providing the display configuration information comprises the step of providing display size and display resolution information to the wireless communication module for configuring the display settings thereof.

7. The method of claim 1 wherein the step of providing the configuration information comprises the step of providing user interface configuration information to the wireless communication module for configuring the operational parameters thereof.

8. The method of claim 1 wherein the step of providing the configuration information comprises the step of providing radio frequency (RF) compensation information to the wireless communication module for configuring the operational parameters thereof.

9. The method of claim 8 wherein the step of providing the RF compensation information comprises the step of providing RF compensation information from the set of (a) transmitter circuitry power settings, (b) transmitter circuitry power limits for different RF bands, (c) receiver circuitry level settings for different RF bands, (d) antenna related gain settings, and (e) antenna related impedance settings.

10. The method of claim 1 wherein the step of providing the configuration information comprises the step of providing audio path compensation information to the wireless communication module for configuring the operational parameters thereof.

11. The method of claim 10 wherein the step of providing the audio path compensation information comprises the step of providing audio path compensation information from the set of (a) uplink gain offsets, (b) downlink gain offsets, (c) audio filter parameters, (d) transducer isolation data, and (e) echo-cancellation parameters.

12. A portable electronic device comprising:
a module coupler for physically and electrically coupling a wireless communication module thereto; and
a controller coupled to the module coupler for providing configuration information to the wireless communication module for configuring the operational parameters thereof in response to detecting coupling of the wireless communication module to the portable electronic device.

13. The portable electronic device of claim 12 wherein the controller provides audio configuration information to the wireless communication module for configuring the operational parameters of audio output devices of the wireless communication module.

14. The portable electronic device of claim 13 wherein the controller provides a speaker phone select signal to the wireless communication module for configuring the operational parameters of the audio output devices to permit operation as a speaker phone or prevent operation as a speaker phone.

15. The portable electronic device of claim 12 wherein the controller provides display configuration information to the wireless communication module for configuring operational parameters thereof.

16. The portable electronic device of claim 15 wherein the controller provides a display resolution signal to the wireless communication module for configuring the operational parameters thereof.

17. The portable electronic device of claim 12 wherein the controller provides user interface configuration information to the wireless communication module for configuring the operational parameters thereof.

18. A method in a wireless communication module coupleable to a portable electronic device, the method comprising the steps of:
coupling the wireless communication module to the portable communication device; and
receiving configuration information from the portable communication device for configuring the operational parameters of the wireless communication module.

19. The method of claim 18 wherein the step of receiving the configuration information comprises the step of receiving audio configuration information from the portable communication device for configuring the operational parameters of audio output devices of the wireless communication module.

20. The method of claim 19 wherein the step of receiving the audio configuration information comprises the step of receiving audio path gain setting information from the portable communication device for configuring the operational parameters of radio frequency (RF) receiver circuitry and transmitter circuitry.

21. The method of claim 19 wherein the step of receiving the audio configuration information comprises the step of receiving speaker phone setting information from the portable communication device for configuring the operational parameters of the audio output devices to operate as a speaker phone or not operate as a speaker phone.

22. The method of claim 18 wherein the step of receiving the configuration information comprises the step of receiving display configuration information from the portable communication device for configuring display settings of the wireless communication module.

23. The method of claim 22 wherein the step of receiving the display configuration information comprises the step of receiving display resolution information from the portable communication device for configuring the display settings of the wireless communication module.

24. The method of claim 18 wherein the step of providing the configuration information comprises the step of providing user interface configuration information from the portable communication device for configuring the operational parameters of the wireless communication module.

25. A wireless communication module comprising:
a coupler for physically and electrically coupling the wireless communication module to a portable electronic device; and
a module controller coupled to the coupler for receiving configuration information from the portable electronic device for configuring the operational parameters of the wireless communication module in response to detecting coupling of the wireless communication module to the portable electronic device.

26. The wireless communication module of claim 25 further comprising:
an antenna for receiving radio frequency (RF) signals;
receiver circuitry coupled to the antenna and the module controller for demodulating and decoding the RF signals to derive received information and providing the information to the module controller;
transmitter circuitry coupled to the antenna and the module controller for receiving information from the module controller and for encoding and modulating the information to derive RF signals for providing to the antenna for transmission therefrom, and
wherein the module controller receives audio path gain setting information from the portable electronic device and wherein the module controller configures audio path gain settings of the antenna, receiver circuitry and transmitter circuitry in response to the audio path gain setting information received from the portable electronic device.

27. The wireless communication module of claim 25 further comprising audio output devices coupled to the module controller, and wherein the module controller receives audio configuration information from the portable electronic device for configuring the operational parameters of the audio output devices.

28. The wireless communication module of claim 27 wherein the module controller configures the audio output devices to permit operation as a speaker phone or prevent operation as a speaker phone in response to a speaker phone select signal received from the portable electronic device.

29. The wireless communication module of claim 25 wherein the module controller configures display settings thereof in response to configuration information received from the portable electronic device.

30. The wireless communication module of claim 29 wherein the module controller configures display resolution settings thereof in response to a display resolution signal received from the portable electronic device.

31. The wireless communication module of claim 25 wherein the module controller configures operational parameters thereof in response to user interface configuration information received from the portable electronic device.
